(19) United States
(12) Patent Application Publication
(10) Pub. No.: US 2026/0055656 A1
(43) Pub. Date: Feb. 26, 2026

(54) SHRINK-EXPAND FIT SYSTEM FOR WINDOW INSERTS

(71) Applicants: HWANG-HSING CHEN, ALLEN, TX (US); KEVIN CHEN, SAN ANTONIO, TX (US)

(72) Inventors: HWANG-HSING CHEN, ALLEN, TX (US); KEVIN CHEN, SAN ANTONIO, TX (US)

(21) Appl. No.: 19/271,510

(22) Filed: Jul. 16, 2025

Related U.S. Application Data
(60) Provisional application No. 63/686,814, filed on Aug. 25, 2024.

(51) Int. Cl. E06B 3/28; E06B 9/00; E06B 9/02

(52) U.S. Cl. CPC E06B 3/28; E06B 9/02; E06B 2009/005

(57) ABSTRACT

A shrink-expand fit system for mounting a panel within an existing window frame. The system includes an elongated shrinkable-expandable elastic portion and an elongated groove portion. The groove portion is configurated to securely receive and hold the panel. The shrinkable portion can be sealed to create an airtight space. The shrinkable portion includes a vacuum seal valve and can shrink under vacuum and expand under atmospheric pressure to tightly hold the panel against the window frame.

### CROSS REFERENCE TO RELATED APPLICATIONS:

This application claims the benefit of an earlier filing date and right of priority to U.S. Provisional Application No. 63/686,814, filed 25 Aug. 2024, the contents of which is incorporated by reference herein in its entirety.

### BACKGROUND OF THE INVENTION

### 1. Field of the Invention

The present application relates to a mounting system for window inserts or storm windows, and more particularly to a shrink-expand fit system for window inserts or storm windows. The shrink-expand fit system is easily mounted on a panel to give window inserts that can be installed within an existing window frame to increase sound and thermal insulation.

### 2. Description of Related Art

Windows have one of the most important functions of a house, they allow plenty of light to enter the house, but they insulate heat in summer and cold in winter to protect the comfortable temperature inside the house. In addition, it can also block out outdoor noise and keep the room quiet. However, when the windows are getting old, the thermal and acoustic insulation of the windows will also be reduced, or when the new windows need additional and better functions, besides the option to replace with the higher performance windows, it is also a good idea to install window inserts or storm windows inside or outside the existing windows.

Many current commercially available window inserts, or storm window systems are difficult to install and remove. Most current window inserts systems are mechanically or magnetically attached with mounting hardware to either the inside or outside of the main window. Most of these windows are heavy and difficult to manipulate. Some of these windows are light and maybe easy to be installed but often difficult to be installed accurately.

U.S. Pat. No. 5,276,658 discloses acoustic window and method of fabricating a transducer acoustic window for a marine environment.

ACOUSTICAL SURFACES, INC. provides several Climate Seal™ Acoustic Series Soundproof Window Inserts that are magnetically attached to window frames.

SOUNDPROOF COW, INC. provides window inserts that are mechanically hang on near existing window frames.

MAGNETITE™ and FANTASTIC FRAME™ window inserts and are also mechanically attached to metal trim pieces screwed on around existing window frames.

U.S. Pat. Nos. 9,976,335 B2, and 8,272,178 B2 discloses press-fit storm window to increase R-value (insulation efficiency) to reduce energy waste and increase sound insulation for acoustic comfort. The system includes an elongated deformable bulb that can be pressed to fit within existing window frames. The press-fit storm window inserts provided a less expensive way to increase the thermal and acoustic properties without the hassle and expense of replacing the existing window. However, to reach the maximum thermal and sound insulation the size of the panel of window inserts should be as large as possible. That larger size panel will cause the deformable bulb to deform more and tightly attached within the window frame. In addition, the large elastic force of the elongated bulb will make the removal or readjustment difficult (if not mounted correctly at first). On the contrary, when a smaller panel is used the elastic force of the bulb will be less and the removal or readjustment will be easier. However, the window insert may not have enough elastic force to hold within the window frame and also a smaller panel will reduce its thermal and sound insulation effect. Embodiments of the invention address these and other problems in the prior art.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1A is a cross-section view of a portion of a window mounting system connected to a panel according to embodiments of the present invention.

FIG. 1B is a cross-section view of a portion of a window mounting system connected to a panel. The mounting system is in the shrink mode.

FIG. 1C is a cross-section view of a portion of a window mounting system connected to a panel. The mounting system in the shrink mode is placed inside the window frame.

FIG. 1D is a cross-section view of a portion of a window mounting system connected to a panel. Then the vacuum seal valve is open to the atmosphere to expand the expandable portion to push against the window frame tightly.

FIG. 2A is a perspective view of a corner of the mounting system in the expand mode.

FIG. 2B is a perspective view of a corner of the mounting system in the shrink mode.

FIG. 3A is a front view of a mounting system connected to a panel in the expand mode.

FIG. 3B is a front view of a mounting system connected to a panel in the shrink mode.

FIG. 3C is a front view of a mounting system connected to a panel in the shrink mode and placed inside a window frame.

FIG. 3D is a front view of a mounting system connected to a panel, placed inside a window frame and expanded to fit tightly inside the window frame.

FIG. 4A and FIG. 4B are other preferred shapes of the shrinkable-expandable portion besides that in FIG. 1A.

FIG. 5A is a cross-section view of the mounting system attached on the panel in the expand mode.

FIG. 5B is a cross-section view of the mounting system attached on the panel in the shrink mode.

FIG. 5C is a cross-section view of the mounting system attached on the panel (to make a window insert) mounted within the window frame in the expand mode.

### DETAILED DESCRIPTION OF THE INVENTION

Embodiments of the invention are directed to a shrink-expand fit system that can be securely attached to a panel to form a window insert or storm window that can be easily and readily installed within a window frame of an existing window. The panel may be made of glass, plastic, such as PLEXIGLASS, or other clear, generally rigid material. In other embodiments the shrink-expand fit window system attached to a panel can be connected to a vacuum source, such as handheld vacuum sealer, through a vacuum sealer valve. The elastic portion of the system can be shrunk gradually until the overall size of the storm window is slightly smaller than the size of the window frame. The shrunk storm window can be easily placed into the window frame at the right position. Then the vacuum sealer valve can be open to allow the elastic portion of the system to expand within the window frame and the storm window can frictionally hold the storm window firmly in place without the need of mounting hardware. The advantage of the system is the shrink-expand mounting process is completely reversible and can be repeated until satisfactory. The space inside the elastic portion, especially at the bottom, can be empty or filled partially/totally with other elastic material, such as memory form to regulate the shrink-expand process and to balance the weight of the storm window on the bottom part of the elastic portion, as described below.

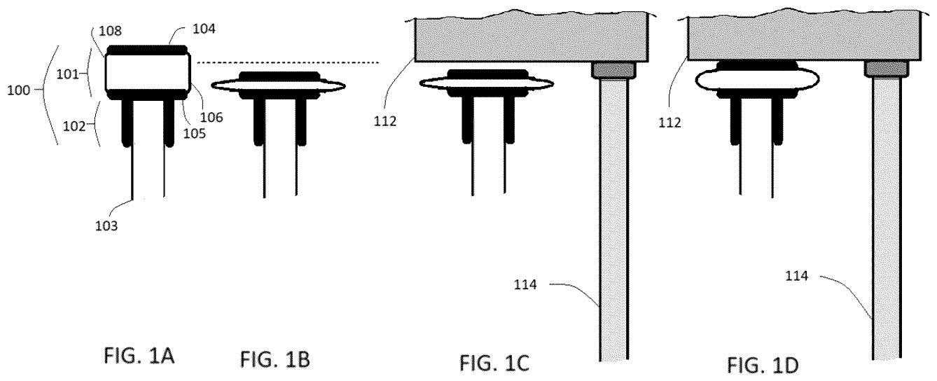

FIG. 1A is a cross-section view of a portion of a window mounting system connected to a panel according to embodiments of the present invention. The system 100 generally includes a shrinkable-expandable portion 101 and a groove portion 102 that securely holds a part of the edge of the panel 103. The groove portion 102 can be used together or replaced with adhesive for bonding of the mounting system 100 to the panel 103.

FIG. 1B is a cross-section view of a portion of a window mounting system 100 connected to a panel 103. The mounting system 100 is in the shrink mode. The shrinkable-expandable portion 101 has preferably thinner walls 106 and 108 at both side than the walls 104 and 105 at the top and bottom. The walls 106 and 108 are preferably narrower than the walls 104 and 105 at the top and the bottom to facilitate the shrinking at the two walls 106 and 108.

FIG. 1C is a cross-section view of a portion of a window mounting system 100 connected to a panel 103. The dimensions of the mounting system 100 with the panel 103 in the shrinking mode is smaller than that of the window frame and can be easily placed inside the window frame 112.

FIG. 1D is a cross-section view of a portion of a window mounting system 100 connected to a panel 103. After the mounting system 100 with the panel 103 in the shrink mode is placed inside the window frame 112, then the vacuum seal valve can be open to the atmosphere to expand the expandable portion 101 to push against the window frame 112 tightly.

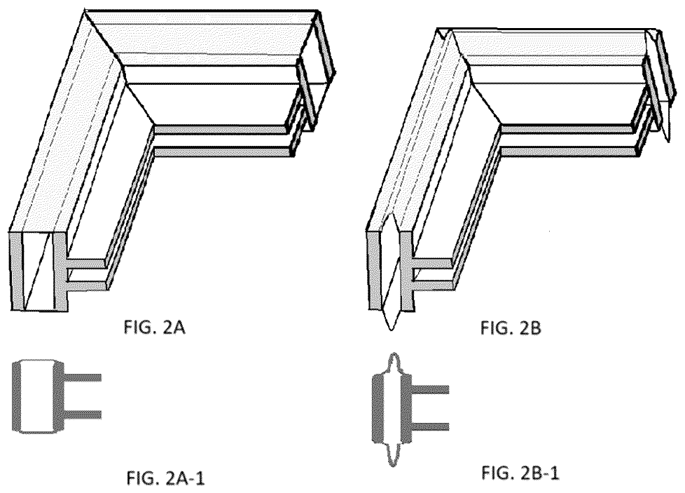

FIG. 2A is a perspective view of a corner of the mounting system in the expand mode and 2A-1 is a cross-section view.

FIG. 2B is a perspective view of a corner of the mounting system in the shrink mode and 2B-1 is a cross-section view.

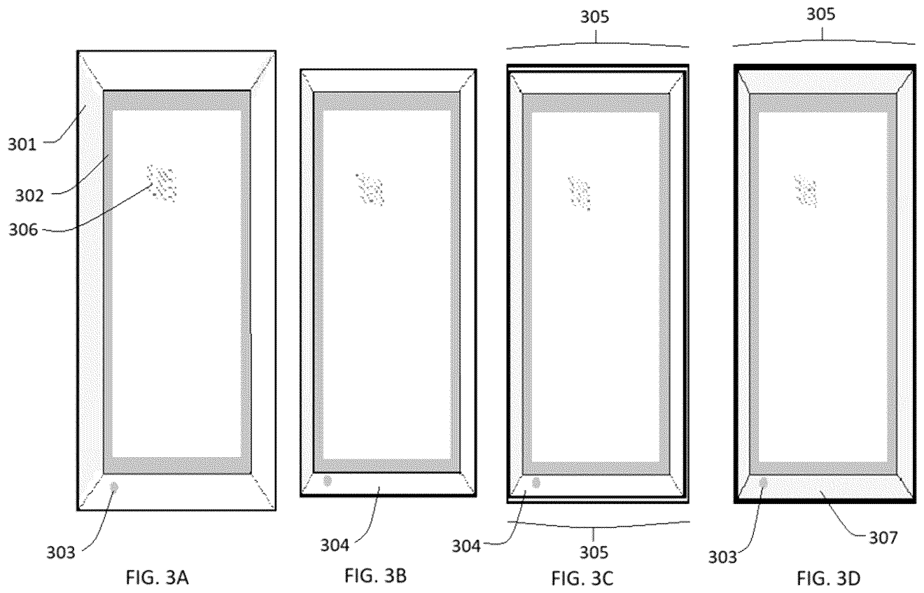

FIG. 3A is a front view of a mounting system 301, 302 connected to a panel 306 in the expand mode. The expandable-shrinkable portion 301 is in the expand mode and the groove portion 302 securely holds the panel 306. The vacuum sealer valve 303 is open to the atmosphere.

FIG. 3B is a front view of a mounting system connected to a panel in the shrink mode. The vacuum sealer valve 303 is connected to a vacuum source to shrink the shrinkable portion 301 to 304.

FIG. 3C is a front view of a mounting system connected to a panel in the shrink mode and placed inside a window frame 305. The overall dimensions of the mounting system plus the panel is slightly small than the window frame and can be freely adjusted to the best position before expanding against the window frame.

FIG. 3D is a front view of a mounting system connected to a panel, placed inside a window frame 305 and the vacuum sealer valve 303 is open to the atmosphere to expand the expandable portion 307 to fit tightly inside the window frame 305. The depths of the shrinkable-expandable portion are designed to be in the order of 303>307>304. The dimensions of the mounting system plus the panel and dimensions of the window frame are designed to be in the order: the expand mode>the window frame 305>the shrink mode.

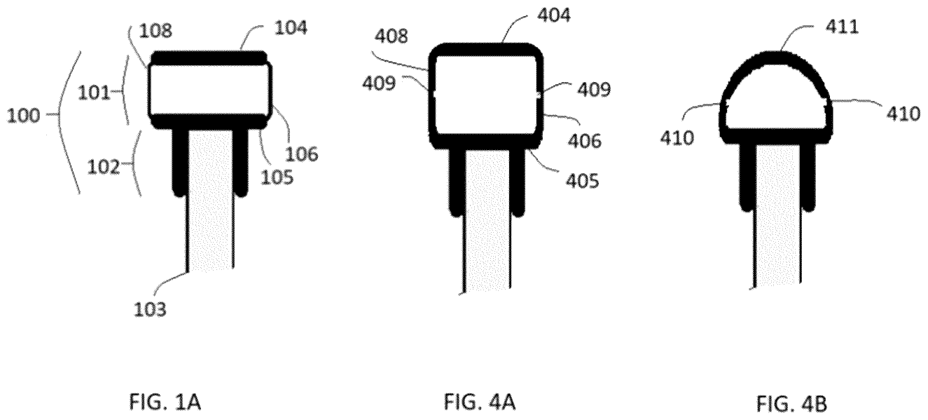

FIG. 4A and FIG. 4B are other preferred shapes of the shrinkable-expandable portion besides that in FIG. 1A. FIG. 4A has a square shape but has thicker walls 404, 405 than the side walls 406, 408 therefore, should facilitate the shrinking process to shrink more between 404 and 405 rather than between 406 and 408. The optional relief grooves 409 can be added to facilitate the shrinking process.

FIG. 4B has a half round or oval shape. The top thinker wall 411 and the relief grooves 410 can be used to facilitate the shrinking process.

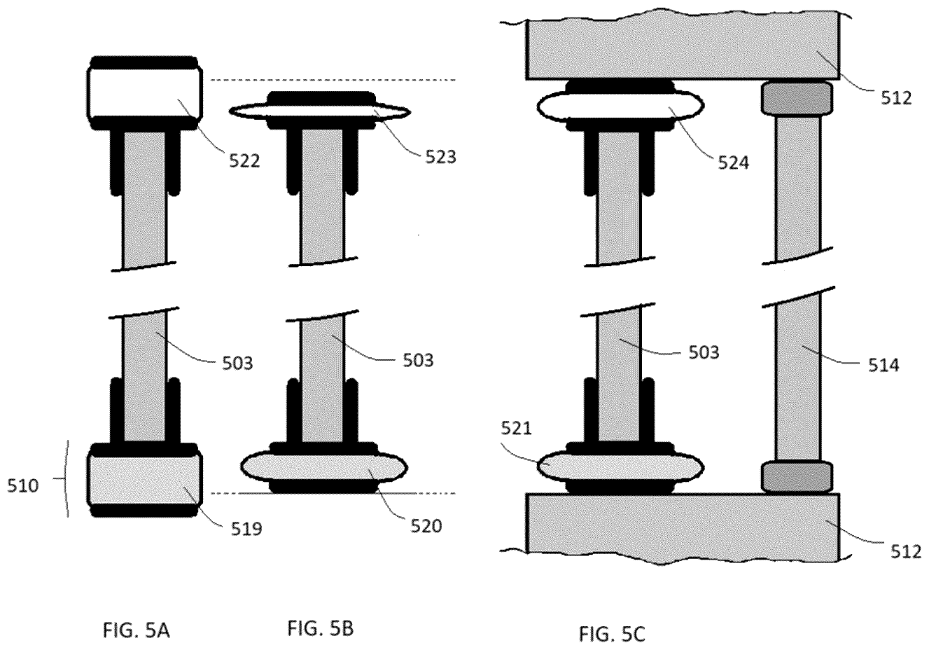

FIG. 5A is a cross-section view of the mounting system attached on the panel 503 in the expand mode. The space 519 inside the shrinkable-expandable portion 510 is added with elastic and flexible material, such as polyurethane foam, memory foam to overcome the weight of the system but the space 522 is empty.

FIG. 5B is a cross-section view of the mounting system attached on the panel 503 in the shrink mode. The shrinkable-expandable portion 520 at the bottom is shrunk less than 523 at the top because the added elastic material.

FIG. 5C is a cross-section view of the mounting system attached on the panel 503 (window insert) mounted within the window frame 512, in the expand mode. The window insert in the shrink mode is placed within the existing window frame 512. The vacuum sealer valve is open to the atmosphere to expand the expandable portion against the window frame 512. The final size of the elastic portions 524 and 521 can be controlled by the amount and elastic strength of the flexible foam added inside the expandable portion 519.

What is claimed is:

1. A system for mounting a panel within an existing window frame, the system comprising an elongated elastic tubing having:
a. a shrinkable-expandable portion,
b. a groove portion,
c. an airtight space created by cutting and sealing the elastic tubing,
d. a vacuum seal valve.

2. The system of claim 1, wherein the airtight space can be shrunk by connecting to a vacuum source and can be expanded by opening the vacuum seal valve.

3. The system of claim 1, wherein the shrinkable-expandable portion has relief grooves, or shapes of rectangular or oval, or partially thinner side walls to favor the shrinkage in the desired direction against the panel and the window frame.

4. The system of claim 1, wherein the dimensions of the panel plus the mounting system are designed to be smaller than that of the window frame when in the shrinking mode but larger in the expanding mode.

5. The system of claim 1, wherein the inner space in the shrinkable-expandable portion can be empty or filled with elastic flexible material, such as memory foam to increase the elastic force.

6. The system of claim 1, wherein the inner space in the shrinkable-expandable portion under the bottom of the panel is filled with elastic flexible material, such as memory foam to increase the elastic force to balance the weight of the panel.

7. The system of claim 1, wherein the groove portion can be used together or replaced with adhesive for bonding of the shrinkable-expandable portion to the panel.

8. A system for mounting a panel within an existing window frame, the system comprising an elongated elastic tubing having:
a. a shrinkable-expandable portion,
b. a groove portion,
c. 2, 3, or 4 airtight spaces created by cutting and sealing the elastic tubing,
d. a vacuum seal valve for each airtight space.
